(19) United States
(12) Patent Application Publication
(10) Pub. No.: US 2026/0189162 A1
(43) Pub. Date: Jul. 2, 2026

(54) DOWNWIND STARTING METHOD FOR PERMANENT MAGNET SYNCHRONOUS MOTOR WITHOUT BACK ELECTROMOTIVE FORCE SAMPLING CIRCUIT

(71) Applicant: ZHONGSHAN BROAD-OCEAN MOTOR CO., LTD., Zhongshan (CN)

(72) Inventors: Fei YANG, Guangdong (CN); Yuhang WANG, Guangdong (CN); Xuan CHEN, Guangdong (CN); Chao YANG, Guangdong (CN)

(21) Appl. No.: 19/265,422

(22) Filed: Jul. 10, 2025

(30) Foreign Application Priority Data
Dec. 31, 2024 (CN) 2024119773522

(51) Int. Cl. H02P 1/02; H02P 23/14

(52) U.S. Cl. CPC H02P 1/02; H02P 23/14

(57) ABSTRACT

A downwind starting method for a permanent magnet synchronous motor without a back electromotive force sampling circuit includes utilizing a back electromotive force generated by a rotating magnetic field that is generated through downwind rotation of the permanent magnet rotor before starting the permanent magnet synchronous motor cutting the plurality of phase windings of the stator assembly to control a lower switch transistor of one of the phase windings to be turned on while turning off lower switch transistors of the remaining phase windings, detecting whether a current is generated, and recording time when the current is generated; repeating the above operations until time when a current is generated for each phase winding is obtained; summing the time when the current is generated for each phase winding to obtain an electrical cycle, and calculating an electrical frequency of the motor by using the electrical cycle; and utilizing the electrical frequency and the time when the current is generated for each phase winding to calculate a corresponding position angle of the permanent magnet rotor respectively as a starting position of the motor. Through the method, back electromotive force sampling circuits are reduced, no special treatment is needed for hardware, PCB routing is more simplified, and manufacturing costs are reduced.

### RELATED APPLICATIONS

This application claims priority to Chinese Patent Application Ser. No. 2024119773522, filed Dec. 31, 2024, the disclosure of which is incorporated by reference in its entirety.

### FIELD OF THE DISCLOSURE

The present invention relates to a downwind starting method for a permanent magnet synchronous motor without a back electromotive force sampling circuit.

### BACKGROUND

Permanent magnet synchronous motors using vector control can maximize motor efficiency and ensure silence, and are gradually used in fan and pump systems.

The starting of motors adopting sensorless vector control has always been a challenge in the industry. Because it is difficult to accurately identify the rotational speed and position of a motor by using a motor model based sensorless algorithm when the motor is at a low speed or stationary, a common solution to overcome this issue is to use an open-loop current to forcibly drag a rotor during the starting of the motor, to enable the rotor to reach a certain rotational speed under predetermined acceleration, after which closed-loop field-oriented control is gradually introduced.

Currently, the field-oriented control of permanent magnet synchronous motors with position sensorless vector control includes speed loop control and current loop control, as detailed in the invention patent with application number 202311000331.0 and entitled “METHOD FOR FLYING START OF PERMANENT MAGNET SYNCHRONOUS MOTOR WITH POSITION SENSORLESS VECTOR CONTROL”.

There are various starting methods for a permanent magnet synchronous motor with position sensorless vector control, but in general, they all require estimating the starting position of a rotor before starting. Before starting, the rotor of the permanent magnet synchronous motor has three states: a standstill state, a downwind state, and an upwind state. This application primarily addresses the issue of the downwind starting method for the permanent magnet synchronous motor with position sensorless vector control. The traditional approach is to add a back electromotive force sampling circuit in the circuit, as shown in FIG. 1, where the motor's back electromotive force is measured to calculate the rotor position and rotational speed of the motor. After back electromotive force parameters are sampled, the rotor position and rotational speed are calculated and used as initial values for the observer to achieve downwind starting.

Disadvantages of the above technical solutions are as follows:
1. Additional circuits need to be added for back electromotive force sampling. Since the voltage of motor terminal leads can reach hundreds of volts, while the voltage of a microprocessor is limited to 3.3V, special treatment is needed for hardware to meet safety regulations, resulting in more complex PCB routing and increased costs.
2. After detecting of the rotor position and rotational speed of the motor, the direct observer-based closed-loop starting is performed, which causes significant current impact that potentially damages electronic components.

### SUMMARY

An object of the present invention is to provide a downwind starting method for a permanent magnet synchronous motor without a back electromotive force sampling circuit, which primarily solves the technical problems in the prior art where through a downwind starting method for a permanent magnet synchronous motor with position sensorless vector control, additional circuits need to be added on hardware for back electromotive force sampling, and special treatment is needed for hardware, resulting in more complex PCB routing and increased costs.

A further object of the present invention is to provide a downwind starting method for a permanent magnet synchronous motor without a back electromotive force sampling circuit, which effectively suppresses current impact during starting.

The object of the present invention is achieved through the following technical solutions:
A downwind starting method for a permanent magnet synchronous motor without a back electromotive force sampling circuit, a permanent magnet synchronous motor including a microprocessor, an inverter circuit, a permanent magnet rotor, and a stator assembly, the stator assembly including a stator core and a plurality of phase windings, the inverter circuit including a plurality of bridge arms, each bridge arm including an upper switch transistor and a lower switch transistor, a connection between the upper switch transistor and the lower switch transistor being connected to one end of one of the phase windings, the other ends of the plurality of phase windings being connected, the microprocessor outputting drive signals to control the upper switch transistor and the lower switch transistor of each bridge arm, and the downwind starting method including step I: obtaining a starting position of the permanent magnet rotor: utilizing a back electromotive force generated by a rotating magnetic field that is generated through downwind rotation of the permanent magnet rotor before starting the permanent magnet synchronous motor cutting the plurality of phase windings of the stator assembly to control a lower switch transistor of one of the phase windings to be turned on while turning off lower switch transistors of the remaining phase windings, detecting whether a current is generated, and recording time when the current is generated; repeating the above operations until time when a current is generated for each phase winding is obtained; summing the time when the current is generated for each phase winding to obtain an electrical cycle, and calculating an electrical frequency of the motor by using the electrical cycle; and utilizing the electrical frequency and the time when the current is generated for each phase winding to calculate a corresponding position angle of the permanent magnet rotor respectively as a starting position of the motor; and step II: starting the motor in a certain control manner.

The permanent magnet synchronous motor adopts position sensorless field-oriented control.

The plurality of phase windings refer to three phases, which are a U-phase winding, a V-phase winding, and a W-phase winding, and the inverter circuit includes three bridge arms.

Starting the motor in the certain control manner in step II refers to starting the motor using zero-current control, namely, under conventional field-oriented control, enabling a speed loop to be in an open-loop state and a current loop in a closed-loop state, and controlling given currents of d-axis and q-axis current loops to be zero, thereby maximally suppressing current impact during downwind starting.

The current loop is in the closed-loop state, and Kp and Ki parameters of the current loop are increased, to enhance control of the current loop and achieve current suppression as soon as possible.

Step I is specifically executed as follows: step 1: sending, by the microprocessor, a drive signal to drive a corresponding lower switch transistor of the U-phase winding to be turned on while turning off the remaining switch transistors; step 2: sampling, by the microprocessor, a current of the U-phase winding; and if the current through the U-phase winding is greater than a set threshold, proceeding to the next step; otherwise, continuing to turn on the lower switch transistor of the U-phase winding to sample the U-phase winding current and make a determination; step 3: recording current time as Tu and proceeding to the next step to change a switch transistor control signal; step 4: sending, by the microprocessor, a drive signal to drive a lower switch transistor of the V-phase winding to be turned on while turning off the remaining switch transistors; step 5: sampling, by the microprocessor, a current of the V-phase winding; and if the current through the V-phase winding is greater than a set threshold, proceeding to the next step; otherwise, continuing to turn on the lower switch transistor of the V-phase winding to sample the current of the V-phase winding and make a determination; step 6: recording current time as Tv and proceeding to the next step to change a switch transistor control signal; step 7: sending, by the microprocessor, a drive signal to drive a lower switch transistor of the W-phase winding to be turned on while turning off the remaining switch transistors; step 8: sampling, by the microprocessor, a current of the W-phase winding; and if the current through the W-phase winding is greater than a set threshold, proceeding to the next step; otherwise, continuing to turn on the lower switch transistor of the V-phase winding to sample the current of the W-phase winding and make a determination; step 9: recording current time as Tw and proceeding to the next step to change a switch transistor control signal; step 11: summing Tu, Tv, and Tw to obtain one electrical cycle, thereby calculating a current electrical frequency of the motor: f=1/(Tu+Tv+Tw), and obtaining an initial angle of the permanent magnet rotor based on a moment of step 3, step 6, or step 9, thereby calculating a rotor position angle at any moment: f*2*π*t, where π is pi and t is any moment.

Step 10 is added between step 9 and step 11: in consideration of a robustness of a strategy, adding a data validity verification mechanism, where in the determining mechanism, comparison between Tu, Tv, and Tw is configured to obtain maximum time Tmax and minimum time Tmin, theoretically, the longest time and the shortest time are close, but under certain operating conditions, such as when the motor is in an accelerating or decelerating state, the estimated longest and shortest time are inconsistent, and the determining mechanism is added in which if Tmax>5*Tmin, it indicates that data estimation is inaccurate, and re-proceeding to step 1 for detection is performed.

The set threshold is 0.1 times a rated current of the motor.

Step 11 is also replaced by the following manner: using a rotor position angle at a moment of step 3, step 6, or step 9 as an initial angle, and adding a product of an angular frequency and time, to calculate a rotor position angle at any moment, where the angular frequency is 120°/Tu, 120°/Tv, or 120°/Tw.

Compared with the prior art, beneficial effects of the present invention are as follows:
Effect 1: Back electromotive force sampling circuits are reduced, no special treatment is needed for hardware, PCB routing is more simplified, and manufacturing costs are reduced.
Effect 2: Smooth downwind starting is achieved. By starting the motor using zero-current control, namely, under conventional field-oriented control, enabling a speed loop to be in an open-loop state and a current loop in a closed-loop state, and controlling given currents of d-axis and q-axis current loops to be zero, current impact during downwind starting is maximally suppressed. In addition, the current loop is in the closed-loop state, and Kp and Ki parameters of the current loop are increased, to enhance control of the current loop and achieve current suppression as soon as possible.
Effect 3: Through the experiment, the technical solutions of the present invention prove adaptive to high-speed, medium-speed, and low-speed permanent magnet synchronous motors and have a wide application scope.
Effect 4: The technical solutions of the present invention are not dependent of controller hardware and can be achieved using traditional motor control hardware.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a detection circuit diagram of a back electromotive force of a three-phase permanent magnet synchronous motor with conventional position sensorless vector control;

FIG. 2 is a perspective view of a permanent magnet synchronous motor according to the present invention;

FIG. 3 is a perspective view of a motor controller of a permanent magnet synchronous motor according to the present invention;

FIG. 4 is a cross-sectional view of a permanent magnet synchronous motor according to the present invention;

FIG. 5 is a block diagram of a principle of a motor controller of a permanent magnet synchronous motor according to the present invention;

FIG. 6 is a circuit framework diagram of a permanent magnet synchronous motor according to the present invention;

FIG. 7 is a waveform diagram of a back electromotive force of a three-phase permanent magnet synchronous motor with conventional position sensorless vector control before downwind starting;

FIG. 8 is a circuit diagram of a principle of obtaining a starting position of a permanent magnet rotor according to the present invention;

FIG. 9 is a vector control flowchart of a permanent magnet synchronous motor according to the present invention;

FIG. 10 is a program control flowchart according to the present invention; and

FIG. 11 is a current variation diagram during downwind starting according to the present invention.

### DETAILED DESCRIPTION

The present invention will be described below in further detail through specific embodiments with reference to the accompanying drawings.

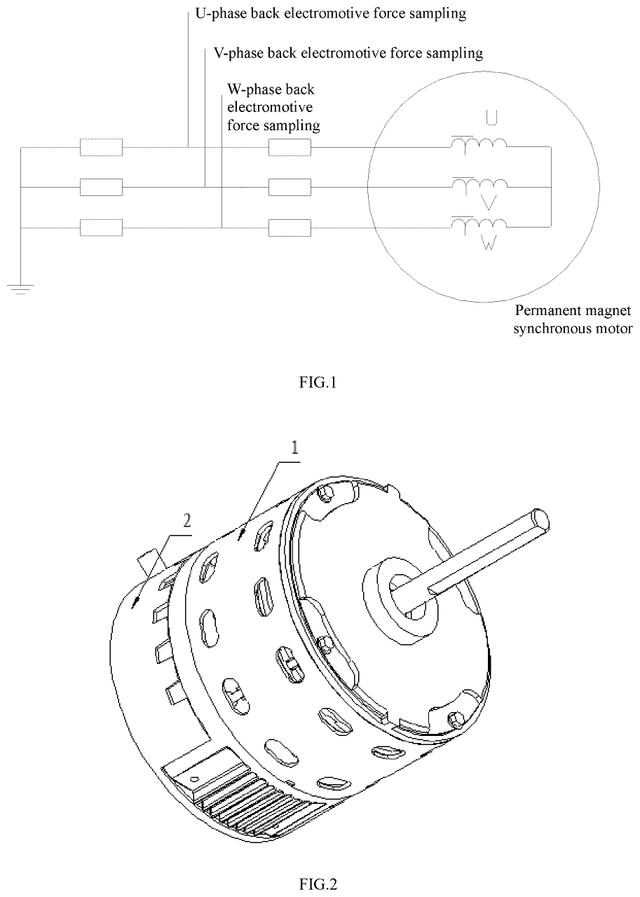

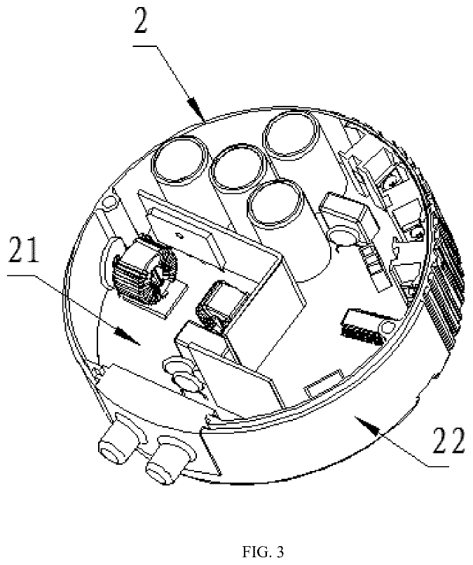

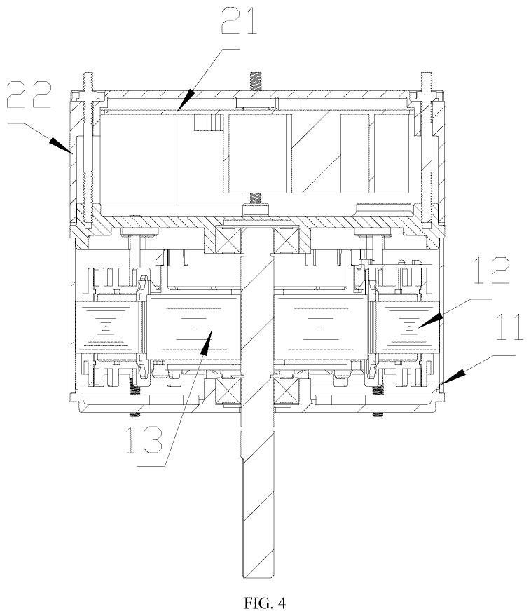

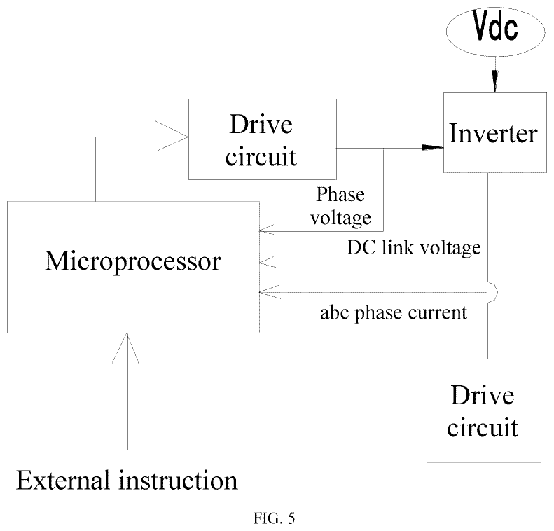

As shown in FIGS. 2, 3, 4, and 5, for example, it is assumed that the present invention provides a three-phase permanent magnet synchronous motor with position sensorless vector control, including a motor controller 2 and a motor body 1. The motor body 1 includes a stator assembly 12, a permanent magnet rotor 13, and a housing assembly 11. The stator assembly 12 is mounted on the housing assembly 11, and the permanent magnet rotor 13 is installed either inside or outside the stator assembly 12. The motor controller 2 includes a control box 22 and a control circuit board 21 installed inside the control box 22. The control circuit board 21 typically includes a power supply circuit, a microprocessor, a bus voltage detection circuit, and an inverter. The power supply circuit provides power to various circuits, the bus voltage detection circuit inputs a direct current bus voltage Vbus to the microprocessor, the microprocessor controls the inverter, and the inverter controls the power on/off of three phase windings of the stator assembly 12. The microprocessor employs a single-chip microprocessor.

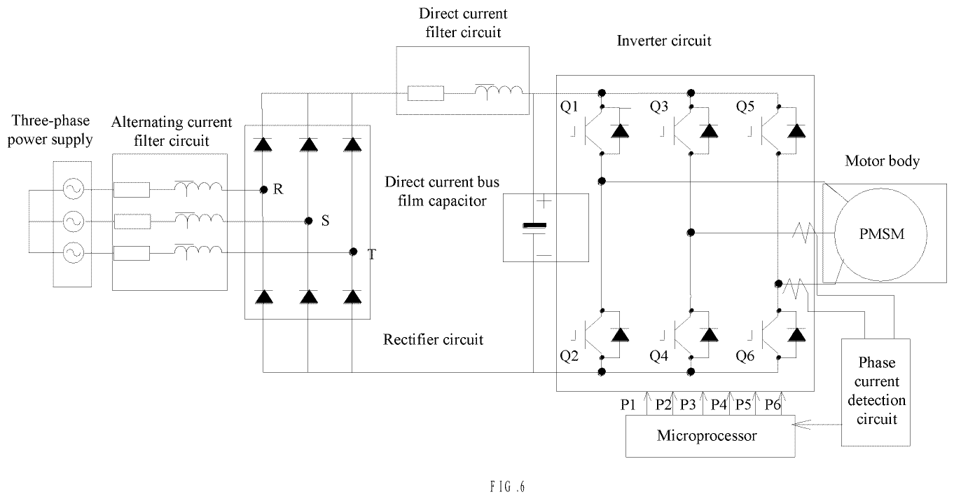

As shown in FIG. 6, the motor controller includes an alternating current filter circuit, a rectifier circuit, a direct current filter circuit, a direct current bus capacitor, an inverter, a microprocessor, and a phase current detection circuit. The three-phase power supply (alternating current power supply) sequentially passes through the alternating current filter circuit, the rectifier circuit, and the direct current filter circuit to charge the direct current bus capacitor, which then provides high-voltage direct current power to the inverter. The phase current detection circuit performs detection on the phase current flowing through the three phase windings and sends the phase current to the microprocessor. The microprocessor controls the inverter circuit to operate. The inverter circuit controls the power on/off of each phase winding of the stator assembly. The permanent magnet synchronous motor adopts the field-oriented control manner. The motor body 1 is a three-phase motor, and the stator assembly of the motor body 1 contains the three phase windings. The inverter includes three bridge arms, where upper bridge arm electronic switch transistors are Q1, Q3, and Q5, also referred to as upper switch transistors, and lower bridge arm electronic switch transistors are Q2, Q4, and Q6, also referred to as lower switch transistors. PMSM is the English abbreviation for permanent magnet synchronous motor. In the present invention, a three-phase permanent magnet synchronous motor is used as an instance of the permanent magnet synchronous motor to illustrate the operating principle of the present invention. The stator assembly 12 includes a stator core and the three phase windings U, V, and W wound around the stator core.

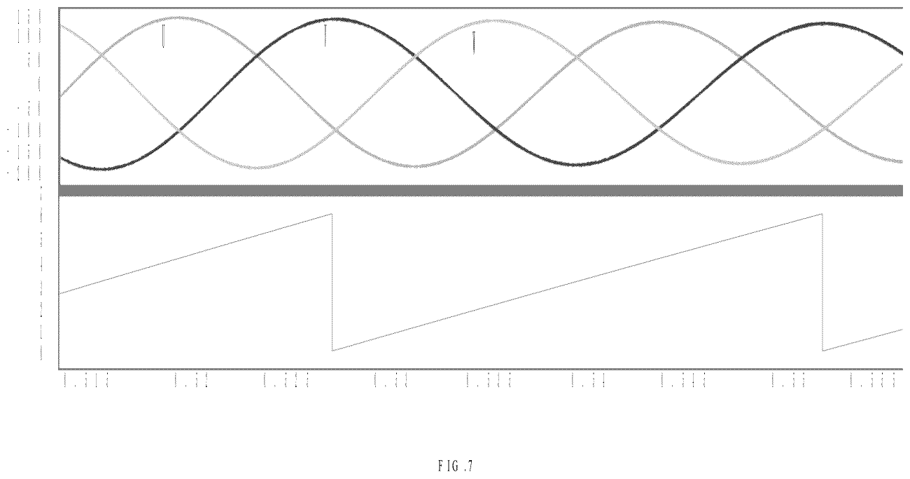

It is known that if a three-phase permanent magnet synchronous motor is in a downwind rotation state before starting, the back electromotive force waveforms of three phase windings are as shown in FIG. 7.

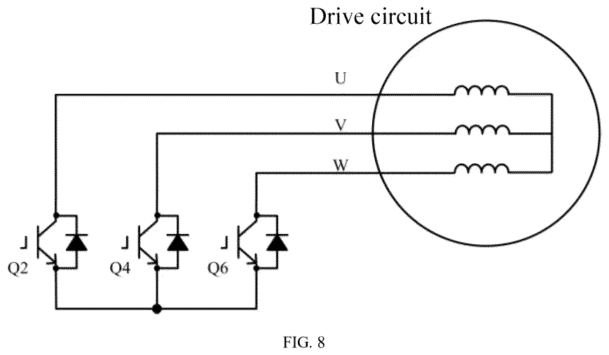

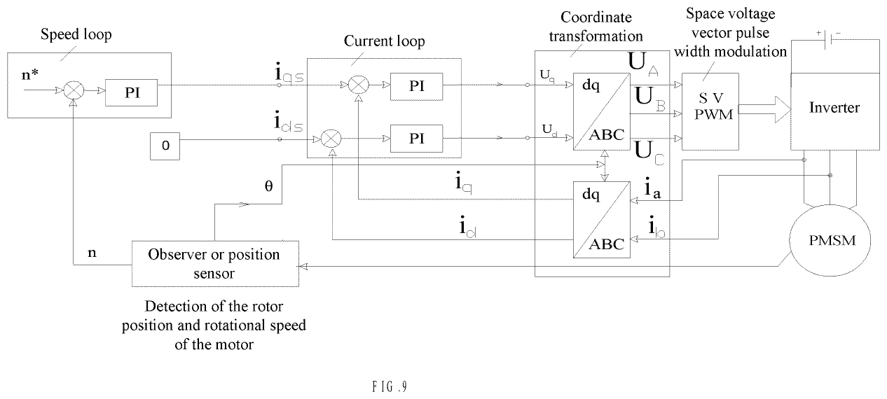

The technical solutions of the present invention only require controlling lower switch transistors of each bridge arm, and all corresponding upper switch transistors of the three phase windings remain in the powered-off state. Thus, a simplified diagram of the principle is shown in FIG. 8. The solution involves controlling a single lower switch transistor and detecting the winding current corresponding to the lower switch transistor. It is known that at any moment, only one phase winding has the minimum back electromotive force. For example, in the range of 0° to 120°, the U-phase winding has the minimum back electromotive force. In this case, the lower switch transistor Q2 of the U-phase is driven to be turned on, while the lower switch transistors Q4 and Q6 of other two phases are not turned on. Due to the anti-parallel diodes in the lower switch transistors of the V and W phase windings, the lower switch transistors of the V and W phase windings fail to be turned on, resulting in no current in the three phase windings. When the motor angle exceeds 120°, the U-phase winding no longer has the minimum back electromotive force. Since the lower switch transistor Q2 of the U-phase winding is continuously driven to be turned on, a phase current is generated in the U-phase winding. Through calculation, the time duration of this interval can be obtained, thereby obtaining the rotational speed of the operating motor and the motor rotor position angle at current generation through calculation.

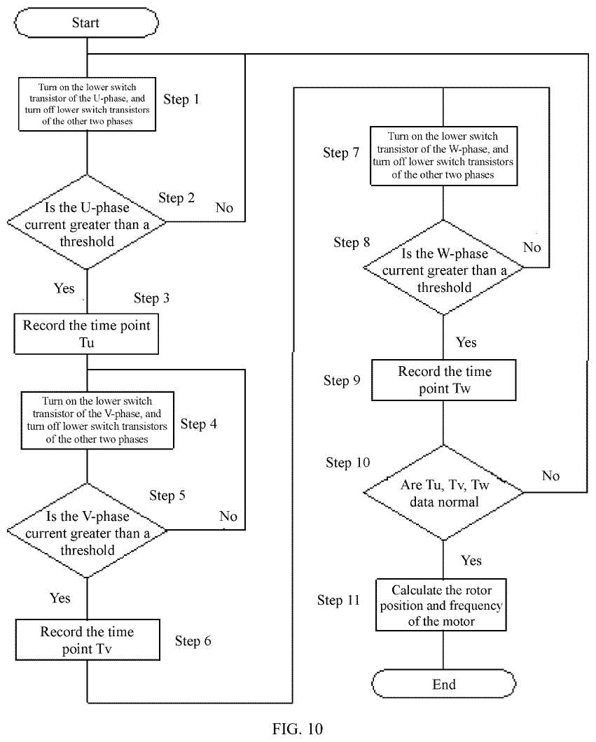

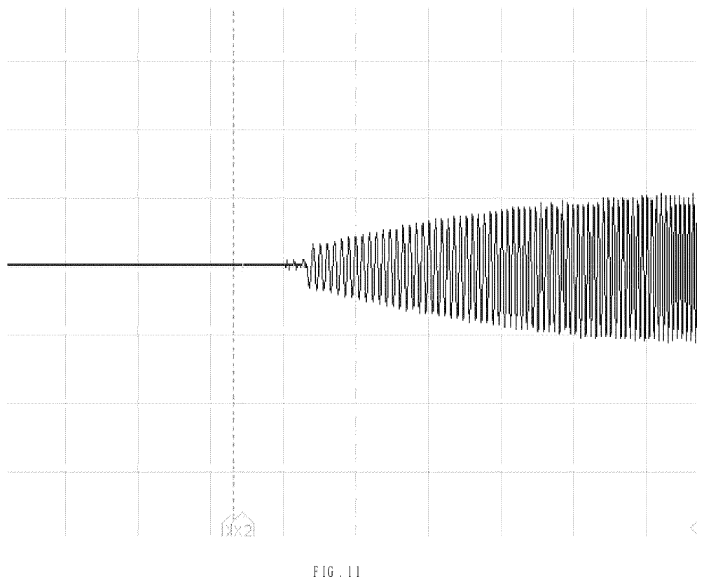

As shown in FIG. 2 to FIG. 10, according to a downwind starting method for a permanent magnet synchronous motor without a back electromotive force sampling circuit in the present invention, a permanent magnet synchronous motor including a microprocessor, an inverter circuit, a permanent magnet rotor, and a stator assembly, the stator assembly including a stator core and a plurality of phase windings, the inverter circuit including a plurality of bridge arms, each bridge arm including an upper switch transistor and a lower switch transistor, a connection between the upper switch transistor and the lower switch transistor being connected to one end of one of the phase windings, the other ends of the plurality of phase windings being connected, the microprocessor outputting drive signals to control the upper switch transistor and the lower switch transistor of each bridge arm, and the downwind starting method including the following steps:
step I: obtaining a starting position of the permanent magnet rotor: utilizing a back electromotive force generated by a rotating magnetic field that is generated through downwind rotation of the permanent magnet rotor before starting the permanent magnet synchronous motor cutting the plurality of phase windings of the stator assembly to control a lower switch transistor of one of the phase windings to be turned on while turning off lower switch transistors of the remaining phase windings, detecting whether a current is generated, and recording time when the current is generated; repeating the above operations until time when a current is generated for each phase winding is obtained; summing the time when the current is generated for each phase winding to obtain an electrical cycle, and calculating an electrical frequency of the motor by using the electrical cycle; and utilizing the electrical frequency and the time when the current is generated for each phase winding to calculate a corresponding position angle of the permanent magnet rotor respectively as a starting position of the motor; and
step II: starting the motor in a certain control manner.

The permanent magnet synchronous motor adopts position sensorless field-oriented control.

The plurality of phase windings refer to three phases, which are a U-phase winding, a V-phase winding, and a W-phase winding, and the inverter circuit includes three bridge arms.

Starting the motor in the certain control manner in step II refers to starting the motor using zero-current control, namely, under conventional field-oriented control, enabling a speed loop to be in an open-loop state and a current loop in a closed-loop state, and controlling given currents of d-axis and q-axis current loops to be zero, thereby maximally suppressing current impact during downwind starting.

The current loop is in the closed-loop state, and Kp and Ki parameters of the current loop are increased, to enhance control of the current loop and achieve current suppression as soon as possible. The Kp and Ki parameters are parameters for PID control of the current loop.

Step I is specifically executed as follows:
step 1: sending, by the microprocessor, a drive signal to drive a lower switch transistor of the U-phase winding to be turned on while turning off the remaining switch transistors;
step 2: sampling, by the microprocessor, a current of the U-phase winding; and if the current through the U-phase winding is greater than a set threshold, proceeding to the next step; otherwise, continuing to turn on the lower switch transistor of the U-phase winding to sample the U-phase winding current and make a determination;
step 3: recording current time as Tu and proceeding to the next step to change a switch transistor control signal, where a timer is reset to zero;
step 4: sending, by the microprocessor, a drive signal to drive a lower switch transistor of the V-phase winding to be turned on while turning off the remaining switch transistors;
step 5: sampling, by the microprocessor, a current of the V-phase winding; and if the current through the V-phase winding is greater than a set threshold, proceeding to the next step; otherwise, continuing to turn on the lower switch transistor of the V-phase winding to sample the current of the V-phase winding and make a determination;
step 6: recording current time as Tv and proceeding to the next step to change a switch transistor control signal, where a timer is reset to zero;
step 7: sending, by the microprocessor, a drive signal to drive a lower switch transistor of the W-phase winding to be turned on while turning off the remaining switch transistors;
step 8: sampling, by the microprocessor, a current of the W-phase winding; and if the current through the W-phase winding is greater than a set threshold, proceeding to the next step; otherwise, continuing to turn on the lower switch transistor of the V-phase winding to sample the current of the W-phase winding and make a determination;
step 9: recording current time as Tw and proceeding to the next step to change a switch transistor control signal;
step 11: summing Tu, Tv, and Tw to obtain one electrical cycle, thereby calculating a current electrical frequency of the motor: f=1/(Tu+Tv+Tw), and obtaining an initial angle of the permanent magnet rotor based on a moment of step 3, step 6, or step 9, thereby calculating a rotor position angle at any moment: f*2*π*t, where π is pi and t is any moment.

During proceeding to the next step to change the switch transistor control signal in step 3, step 6, or step 9, the timer is reset to zero.

Step 10 is added between step 9 and step 11: in consideration of a robustness of a strategy, adding a data validity verification mechanism, where in the determining mechanism, comparison between Tu, Tv, and Tw is configured to obtain maximum time Tmax and minimum time Tmin, theoretically, the longest time and the shortest time are close, but under certain operating conditions, such as when the motor is in an accelerating or decelerating state, the estimated longest and shortest time are inconsistent, and the determining mechanism is added in which if Tmax>5*Tmin, it indicates that data estimation is inaccurate, and re-proceeding to step 1 for detection is performed.

The set threshold is 0.1 times a rated current of the motor.

Step 11 is also replaced by the following manner: using a rotor position angle at a moment of step 3, step 6, or step 9 as an initial angle, and adding a product of an angular frequency and time, to calculate a rotor position angle at any moment t, where the angular frequency is 120°/Tu, 120°/Tv, or 120°/Tw.

The manner of obtaining the starting position of the permanent magnet rotor in step I of the present invention is not only applicable to three-phase permanent magnet synchronous motors, but also applicable to five-phase or six-phase permanent magnet synchronous motors. This is because, in principle, the manner can be adapted to permanent magnet synchronous motors with more than three-phase windings. Details are not described herein again.

Compared with the prior art, beneficial effects of the present invention are as follows:
Effect 1: Back electromotive force sampling circuits are reduced, no special treatment is needed for hardware, PCB routing is more simplified, and manufacturing costs are reduced.
Effect 2: Smooth downwind starting is achieved. By starting the motor using zero-current control, namely, under conventional field-oriented control, enabling a speed loop to be in an open-loop state and a current loop in a closed-loop state, and controlling given currents of d-axis and q-axis current loops to be zero, current impact during downwind starting is maximally suppressed. In addition, the current loop is in the closed-loop state, and Kp and Ki parameters of the current loop are increased, to enhance control of the current loop and achieve current suppression as soon as possible.
Effect 3: Through the experiment, the technical solutions of the present invention prove adaptive to high-speed, medium-speed, and low-speed permanent magnet synchronous motors and have a wide application scope.
Effect 4: The technical solutions of the present invention are not dependent of controller hardware and can be achieved using traditional motor control hardware.

Strong wind is used externally to drive the fan containing a three-phase permanent magnet synchronous motor into forward downwind operation. Then, the motor is started, and the current waveform is captured during starting, as shown in FIG. 11. It can be seen that there is no current impact essentially, and the smooth downwind starting of the motor can be achieved. In FIG. 1, vertical coordinates represent the starting current, and horizontal coordinates represent time. FIG. 11 is captured using specialized instruments.

The above embodiments are preferred implementations of the present invention. However, implementations of the present invention are not limited thereto. Any modifications, alterations, substitutions, combinations, or simplifications made without departing from the essential spirit and principles of the present invention shall be considered equivalent alternatives and fall within the protection scope of the present invention.

1. A downwind starting method for a permanent magnet synchronous motor without a back electromotive force sampling circuit, a permanent magnet synchronous motor comprising a microprocessor, an inverter circuit, a permanent magnet rotor, and a stator assembly, the stator assembly comprising a stator core and a plurality of phase windings, the inverter circuit comprising a plurality of bridge arms, each bridge arm comprising an upper switch transistor and a lower switch transistor, a connection between the upper switch transistor and the lower switch transistor being connected to one end of one of the phase windings, the other ends of the plurality of phase windings being connected, the microprocessor outputting drive signals to control the upper switch transistor and the lower switch transistor of each bridge arm, and the downwind starting method comprising:
(I) obtaining a starting position of the permanent magnet rotor: utilizing a back electromotive force generated by a rotating magnetic field that is generated through downwind rotation of the permanent magnet rotor before starting the permanent magnet synchronous motor cutting the plurality of phase windings of the stator assembly to control a lower switch transistor of one of the phase windings to be turned on while turning off lower switch transistors of the remaining phase windings, detecting whether a current is generated, and recording time when the current is generated; repeating the above operations until time when a current is generated for each phase winding is obtained; summing the time when the current is generated for each phase winding to obtain an electrical cycle, and calculating an electrical frequency of the motor by using the electrical cycle; and utilizing the electrical frequency and the time when the current is generated for each phase winding to calculate a corresponding position angle of the permanent magnet rotor respectively as a starting position of the motor; and
(II) starting the motor in a certain control manner.

2. The downwind starting method for a permanent magnet synchronous motor without a back electromotive force sampling circuit according to claim 1, wherein the permanent magnet synchronous motor adopts position sensorless field-oriented control.

3. The downwind starting method for a permanent magnet synchronous motor without a back electromotive force sampling circuit according to claim 2, wherein the plurality of phase windings refer to three phases, which are a U-phase winding, a V-phase winding, and a W-phase winding, and the inverter circuit comprises three bridge arms.

4. The downwind starting method for a permanent magnet synchronous motor without a back electromotive force sampling circuit according to claim 3, wherein starting the motor in the certain control manner in (II) refers to starting the motor using zero-current control, namely, under conventional field-oriented control, enabling a speed loop to be in an open-loop state and a current loop in a closed-loop state, and controlling given currents of d-axis and q-axis current loops to be zero, thereby maximally suppressing current impact during downwind starting.

5. The downwind starting method for a permanent magnet synchronous motor without a back electromotive force sampling circuit according to claim 4, wherein the current loop is in the closed-loop state, and Kp and Ki parameters of the current loop are increased, to enhance control of the current loop and achieve current suppression as soon as possible.

6. The downwind starting method for a permanent magnet synchronous motor without a back electromotive force sampling circuit according to claim 3, wherein (I) is specifically executed as follows:
step 1: sending, by the microprocessor, a drive signal to drive a lower switch transistor of the U-phase winding to be turned on while turning off the remaining switch transistors;
step 2: sampling, by the microprocessor, a current of the U-phase winding; and if the current through the U-phase winding is greater than a set threshold, proceeding to the next step; otherwise, continuing to turn on the lower switch transistor of the U-phase winding to sample the U-phase winding current and make a determination;
step 3: recording current time as Tu and proceeding to the next step to change a switch transistor control signal;
step 4: sending, by the microprocessor, a drive signal to drive a lower switch transistor of the V-phase winding to be turned on while turning off the remaining switch transistors;
step 5: sampling, by the microprocessor, a current of the V-phase winding; and if the current through the V-phase winding is greater than a set threshold, proceeding to the next step; otherwise, continuing to turn on the lower switch transistor of the V-phase winding to sample the current of the V-phase winding and make a determination;
step 6: recording current time as Tv and proceeding to the next step to change a switch transistor control signal;
step 7: sending, by the microprocessor, a drive signal to drive a lower switch transistor of the W-phase winding to be turned on while turning off the remaining switch transistors;
step 8: sampling, by the microprocessor, a current of the W-phase winding; and if the current through the W-phase winding is greater than a set threshold, proceeding to the next step;
otherwise, continuing to turn on the lower switch transistor of the V-phase winding to sample the current of the W-phase winding and make a determination;
step 9: recording current time as Tw and proceeding to the next step to change a switch transistor control signal;
step 11: summing Tu, Tv, and Tw to obtain one electrical cycle, thereby calculating a current electrical frequency of the motor: f=1/(Tu+Tv+Tw), and obtaining an initial angle of the permanent magnet rotor based on a moment of step 3, step 6, or step 9, thereby calculating a rotor position angle at any moment: f*2*π*t, wherein π is pi and t is any moment.

7. The downwind starting method for a permanent magnet synchronous motor without a back electromotive force sampling circuit according to claim 6, wherein a step 10 is added between step 9 and step 11 wherein, in consideration of a robustness of a strategy, adding a data validity verification mechanism, wherein in the determining mechanism, comparison between Tu, Tv, and Tw is configured to obtain maximum time Tmax and minimum time Tmin, theoretically, the longest time and the shortest time are close, but under certain operating conditions, such as when the motor is in an accelerating or decelerating state, the estimated longest and shortest time are inconsistent, and the determining mechanism is added in which if Tmax>5*Tmin, it indicates that data estimation is inaccurate, and re-proceeding to step 1 for detection is performed.

8. The downwind starting method for a permanent magnet synchronous motor without a back electromotive force sampling circuit according to claim 7, wherein the set threshold is 0.1 times a rated current of the motor.

9. The downwind starting method for a permanent magnet synchronous motor without a back electromotive force sampling circuit according to claim 6, wherein step 11 is also replaced by the following manner: using a rotor position angle at a moment of step 3, step 6, or step 9 as an initial angle, and adding a product of an angular frequency and time, to calculate a rotor position angle at any moment, wherein the angular frequency is 120°/Tu, 120°/Tv, or 120°/Tw.

10. The downwind starting method for a permanent magnet synchronous motor without a back electromotive force sampling circuit according to claim 4, wherein (I) is specifically executed as follows:
step 1: sending, by the microprocessor, a drive signal to drive a lower switch transistor of the U-phase winding to be turned on while turning off the remaining switch transistors;
step 2: sampling, by the microprocessor, a current of the U-phase winding; and if the current through the U-phase winding is greater than a set threshold, proceeding to the next step; otherwise, continuing to turn on the lower switch transistor of the U-phase winding to sample the U-phase winding current and make a determination;
step 3: recording current time as Tu and proceeding to the next step to change a switch transistor control signal;
step 4: sending, by the microprocessor, a drive signal to drive a lower switch transistor of the V-phase winding to be turned on while turning off the remaining switch transistors;
step 5: sampling, by the microprocessor, a current of the V-phase winding; and if the current through the V-phase winding is greater than a set threshold, proceeding to the next step; otherwise, continuing to turn on the lower switch transistor of the V-phase winding to sample the current of the V-phase winding and make a determination;
step 6: recording current time as Tv and proceeding to the next step to change a switch transistor control signal;
step 7: sending, by the microprocessor, a drive signal to drive a lower switch transistor of the W-phase winding to be turned on while turning off the remaining switch transistors;
step 8: sampling, by the microprocessor, a current of the W-phase winding; and if the current through the W-phase winding is greater than a set threshold, proceeding to the next step; otherwise, continuing to turn on the lower switch transistor of the V-phase winding to sample the current of the W-phase winding and make a determination;
step 9: recording current time as Tw and proceeding to the next step to change a switch transistor control signal;
step 11: summing Tu, Tv, and Tw to obtain one electrical cycle, thereby calculating a current electrical frequency of the motor: f=1/(Tu+Tv+Tw), and obtaining an initial angle of the permanent magnet rotor based on a moment of step 3, step 6, or step 9, thereby calculating a rotor position angle at any moment: f*2*π*t, wherein π is pi and t is any moment.

11. The downwind starting method for a permanent magnet synchronous motor without a back electromotive force sampling circuit according to claim 5, wherein (I) is specifically executed as follows:
step 1: sending, by the microprocessor, a drive signal to drive a lower switch transistor of the U-phase winding to be turned on while turning off the remaining switch transistors;
step 2: sampling, by the microprocessor, a current of the U-phase winding; and if the current through the U-phase winding is greater than a set threshold, proceeding to the next step; otherwise, continuing to turn on the lower switch transistor of the U-phase winding to sample the U-phase winding current and make a determination;
step 3: recording current time as Tu and proceeding to the next step to change a switch transistor control signal;
step 4: sending, by the microprocessor, a drive signal to drive a lower switch transistor of the V-phase winding to be turned on while turning off the remaining switch transistors;
step 5: sampling, by the microprocessor, a current of the V-phase winding; and if the current through the V-phase winding is greater than a set threshold, proceeding to the next step; otherwise, continuing to turn on the lower switch transistor of the V-phase winding to sample the current of the V-phase winding and make a determination;
step 6: recording current time as Tv and proceeding to the next step to change a switch transistor control signal;
step 7: sending, by the microprocessor, a drive signal to drive a lower switch transistor of the W-phase winding to be turned on while turning off the remaining switch transistors;
step 8: sampling, by the microprocessor, a current of the W-phase winding; and if the current through the W-phase winding is greater than a set threshold, proceeding to the next step; otherwise, continuing to turn on the lower switch transistor of the V-phase winding to sample the current of the W-phase winding and make a determination;
step 9: recording current time as Tw and proceeding to the next step to change a switch transistor control signal;
step 11: summing Tu, Tv, and Tw to obtain one electrical cycle, thereby calculating a current electrical frequency of the motor: f=1/(Tu+Tv+Tw), and obtaining an initial angle of the permanent magnet rotor based on a moment of step 3, step 6, or step 9, thereby calculating a rotor position angle at any moment: f*2*π*t, wherein π is pi and t is any moment.
